(19) United States
(12) Patent Application Publication
(10) Pub. No.: US 2003/0072695 A1
(43) Pub. Date: Apr. 17, 2003

(54) Method of removing oxidized portions at an interface of a metal surface and capping layer in a semiconductor metallization layer

(76) Inventors: Hartmut Ruelke, Dresden (DE); Joerg Hohage, Dresden (DE); Minh Van Ngo, Fremont, CA (US); Paul Lawrence King, Mountain View, CA (US); Peter Huebler, Coswig (DE)

Correspondence Address: WILLIAMS, MORGAN & AMERSON, P.C., 10333 RICHMOND, SUITE 1100, HOUSTON, TX, 77042, US

(21) Appl. No.: 10/135,009

(22) Filed: Apr. 29, 2002

(30) Foreign Application Priority Data
Oct. 15, 2001 (DE) 101 50 822.0

(51) Int. Cl. B01J 19/08

(52) U.S. Cl. 422/186; 422/186.06

(57) ABSTRACT

In a method of removing oxidized and discolored portions from a copper surface, a mixture of a reactive gas, such as NH₃, and of a purge gas, such as N₂, is used with a relatively low high-frequency power to substantially remove all of the copper oxide from the surface. Preferably, a silicon-containing capping layer is subsequently formed on the copper surface, wherein the deposition process can be performed immediately after the surface treatment step without any additional transition step, since the process conditions within the reaction chamber, required for the deposition, are already established.

### BACKGROUND OF THE INVENTION

1. Field of the Invention

The present invention relates to the manufacturing of integrated circuits, and, more particularly, to an improved process for reducing irregularities on a surface of a metallization layer, such as a copper metallization layer, in a semiconductor device.

2. Description of the Related Art

The manufacturing process of modem integrated circuits involves the fabrication of numerous semiconductor devices, such as insulated gate field effect transistors, on a single substrate. Feature sizes of the semiconductor devices are steadily decreasing to provide increased integration density of the integrated circuit and improved device performance, for instance with respect to signal processing time and power consumption. The enormous number of semiconductor devices formed on a single chip area, however, reduces the available space for, and hence the cross-section of, metallization lines connecting the individual semiconductor devices. As a consequence, the increased electrical resistance of the metallization lines, due to their reduction in size, begins to offset the advantages regarding signal performance of a transistor device that are obtained by reducing the dimensions of the field effect transistor when a certain amount of reduction of the feature sizes is reached. Particularly, in modem ultra-high density integrated circuits, the so-called interconnect delay of the metal lines formed in the plural metallization layers limits the practicable signal processing speed owing to the increased resistance and the parasitic capacitance of the small metal lines.

The electrical resistance of the metallization lines can be reduced in that aluminum, preferably used in modern integrated circuits, is replaced by a conductive material having a lower specific resistance. One candidate for such a low ohmic material for metallization lines in ultra-high density integrated circuits is copper. Although processing of copper in a semi-conductor production line is extremely difficult, since the slightest contamination of process equipment not involved in the copper process has an adverse effect on the performance of the final devices, copper is the preferred metallization metal in high end integrated circuits exhibiting feature sizes of 0.2 μm and beyond.

Employing a copper metallization layer in semiconductor devices, however, gives rise to additional problems, such as surface irregularities in the form of corrosion, discoloration, hillocks and the like, caused by the high reactivity of a pure copper surface exposed to air or other reactive ambients, thereby ultimately resulting in insufficient adhesion to adjacent materials, the consequence of which is degraded long-time stability of the transistor device. For this reason, after polishing and planarizing the copper metallization layer by means of chemical mechanical polishing (CMP), a reactive plasma treatment is commonly performed in order to try to remove any copper oxide formed on the copper surface that is exposed by the CMP step. In general, a capping layer, usually a silicon nitride layer or a silicon oxynitride layer, is subsequently deposited over the plasma-treated copper metallization layer so as to protect the copper with the capping layer to thereby avoid the generation of surface defects.

A typical prior art process flow for treating a copper metallization layer prior to forming a capping layer may comprise the following process steps. As is well known, after filling openings formed in a dielectric layer with a barrier metal and copper, the excess barrier metal and the excess copper are removed by a CMP step. The resulting surface of the semiconductor structure obtained by the CMP step comprises surface portions of copper as well as surface portions of the dielectric material, wherein the ratio of exposed copper to dielectric material depends on the type of metallization layer and design rules for the integrated circuit under consideration. As previously mentioned, a reactive plasma etch step will typically be performed after the CMP step to remove corrosion, discoloration and the like that primarily consist of copper oxide formed on the exposed copper surface after the CMP step. For treating the copper surface, the wafer bearing the exposed and planarized metallization layer is inserted into a reaction chamber providing a dynamic reactive plasma ambient. The reactive plasma ambient is dynamic in the sense that feed gas is continuously introduced into the chamber and gases are continuously pumped away so that a constant flow rate of the feed gases at a constant pressure is established in the reaction chamber. For removing copper oxide from the surface of the metallization layer, ammonia (NH₃) gas is typically continuously fed to the reaction chamber at a predefined flow rate for a predefined time interval while a predefined pressure is maintained in the reaction chamber. Typical process parameters for a corresponding process may be as follows.

In a set-up step, approximately 800 sccm (standard cubic centimeter per minute) of ammonia (NH₃) at a chamber pressure of approximately 8 Torrs are supplied for approximately 15 seconds. Subsequently, the high-frequency electric field for establishing the plasma is initiated at approximately 200 Watts for about 40 seconds while maintaining both the ammonia (NH₃) flow rate and the pressure in the reaction chamber. Finally, a pump step is carried out for at least 30 seconds to remove reactive gas byproducts created during the ammonia (NH₃) treatment. The duration of the pump step depends on the amount of copper exposed in the metallization layer. Preferably, an in situ deposition step is carried out to form the capping layer immediately after the ammonia (NH₃) treatment. For the deposition of the capping layer, for example a silicon nitride layer, silane gas (SiH₄), is additionally introduced into the reaction chamber. To control the exposure of the ammonia(NH₃)-plasma-treated copper surface to silane gas, a so-called ramp up step may be used in which the flow rate of the silane gas is slowly increased. A typical process flow for the deposition of the silicon nitride layer may comprise the following steps.

First, a set-up step of approximately 5 seconds is carried out with an ammonia (NH₃) flow rate of approximately 260 sccm and a nitrogen flow rate of approximately 8600 sccm. Thereafter, the ramp up step of approximately 5 seconds with a silane flow rate of approximately 50 sccm is performed while maintaining the flow rates for ammonia (NH₃) and nitrogen. After increasing the silane flow rate to approximately 150 sccm, the flow rate is kept constant for about 12-15 seconds to deposit the silicon nitride capping layer. Finally, a purge step of approximately 10 seconds with a nitrogen flow rate of approximately 8600 sccm and a subsequent pumping step of about 10 seconds completes the deposition cycle. According to the process described above, a total time for treating the copper surface and for depositing the silicon nitride layer of approximately 140 seconds is required, resulting in a silicon nitride capping layer having a thickness ranging from approximately 300-800 Å.

However, despite the above processing steps, irregularities on the copper surface at the interface to the silicon nitride layer, such as discoloration, corrosion, copper hillocks and the like, can still be observed. Such defects are mainly caused by reaction byproducts that cannot be effectively removed after the plasma treatment. Another factor is an uncontrolled surface reaction of the copper at the time when the silane gas is initially introduced into the reaction chamber. Although the introduction of a ramp up step for feeding the silane gas significantly reduces the number of irregularities, further improvement in this respect is highly desirable.

A further issue of the prior art processing is the relatively long time required for a complete process cycle that significantly reduces the throughput since the wafers are processed in a single or a double reaction chamber.

In view of the above problems, a need exists for an improved process for reducing surface irregularities and for effectively forming a capping layer over a metallization layer.

### SUMMARY OF THE INVENTION

According to one illustrative embodiment of the present invention, a method of treating a copper surface comprises providing a substrate having formed thereon one or more copper-containing regions with an exposed surface having formed thereon oxidized and discolored portions, and providing a gaseous ambient comprising a mixture of ammonia (NH₃) and nitrogen (N₂). Moreover, the method includes establishing a reactive plasma ambient by supplying high frequency power to the gaseous ambient to remove the oxidized and discolored portions from the exposed surface of the copper-containing regions.

According to a further illustrative embodiment of the present invention, an in situ method of forming a silicon-containing capping layer on a metal surface comprises providing a substrate having formed thereon a metal region with an exposed metal surface having formed thereon oxidized portions, and establishing a reactive plasma ambient by supplying high frequency power to a gaseous ambient comprising a mixture of a reactive gas and a purge gas to reduce the oxidized portions on the metal surface. Furthermore, the method comprises adding silane gas to the reactive plasma ambient to deposit the silicon-containing capping layer.

According to a further embodiment, a method of treating a copper surface comprises providing a substrate having formed thereon one or more copper-containing regions with an exposed surface having oxidized and discolored portions formed thereon, and providing a gaseous ambient comprising a mixture of ammonia and nitrogen in a ratio of approximately 20 to 60, nitrogen to ammonia. The method additionally comprises establishing a reactive plasma ambient by supplying high frequency power to the gaseous ambient to remove the oxidized and discolored portions from the exposed surface of the copper-containing regions.

According to a further embodiment, a method of treating a copper surface comprises providing a substrate having formed thereon one or more copper-containing regions with an exposed surface having oxidized and discolored portions formed thereon, and providing a gaseous ambient comprising a mixture of ammonia and nitrogen, wherein the ammonia is provided at a flow rate in the range of approximately 150-350 sccm and the nitrogen is provided at a flow rate in the range of approximately 7000-9500 sccm. Moreover, the method comprises establishing a reactive plasma ambient by supplying high frequency power to the gaseous ambient to remove the oxidized and discolored portions from the exposed surface of the copper-containing regions.

### BRIEF DESCRIPTION OF THE DRAWINGS

The invention may be understood by reference to the following description taken in conjunction with the accompanying drawings, in which like reference numerals identify like elements, and in which:

FIG. 1 schematically shows a plasma treatment tool that may be used for the method of the present invention;

FIG. 2a schematically shows a cross-sectional view of an example of a substrate including a metal region that is used in the method of the present invention; and

FIG. 2b schematically shows a cross-sectional view of the substrate of FIG. 2a, wherein a capping layer is formed in accordance with the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

In general the present invention is based on the inventors' findings that the establishment of a reactive plasma ambient in the presence of a reactive gas, such as ammonia (NH₃), and a purge gas, such as nitrogen (N₂), instead of merely a reactive gas, significantly affects the characteristics of the copper surface, such as surface roughness, hillock formation, and the number of oxidized and discolored portions. A subsequent formation of a silicon-containing capping layer, therefore, exhibits a required adhesion to the underlying metallization layer with a minimal amount of irregularities, i.e., a minimal number of oxygen-containing portions and reduced hillock formation, and an increased resistance against electromigration to thereby remarkably improve device performance and reliability.

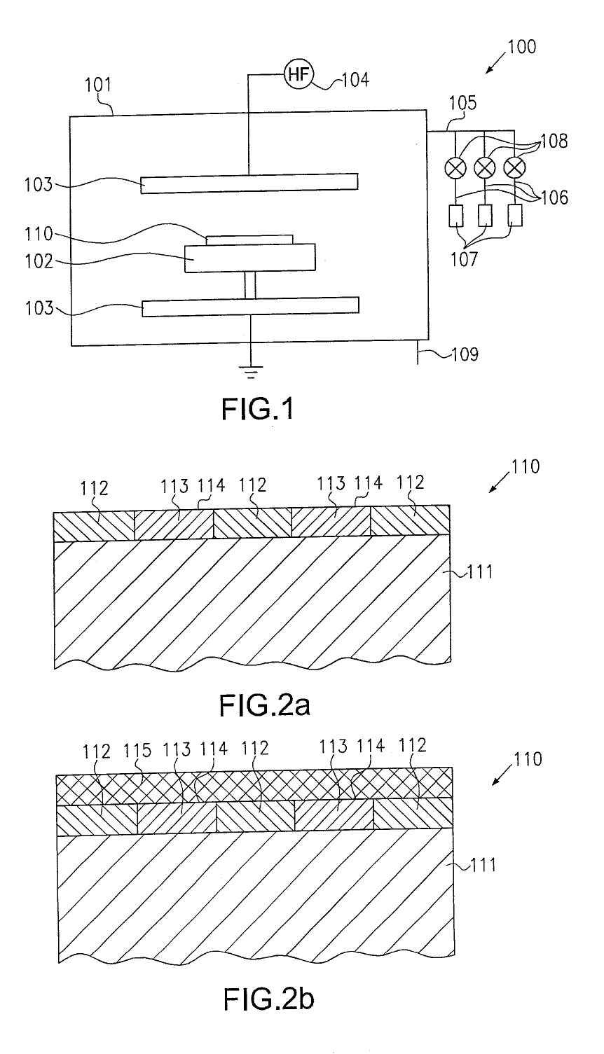

With reference to FIGS. 1, 2a and 2b, illustrative embodiments of the present invention will now be described. FIG. 1 is a schematic view of a plasma treatment tool 100 that may be used in practicing the present invention. The plasma treatment tool 100 comprises a reaction chamber 101 including a pair of electrodes 103 and a substrate stage 102 for receiving a substrate 110 that will be described in more detail with reference to FIG. 2a. One of the electrodes 103 is electrically connected to a high frequency power source 104. Moreover, the reaction chamber 101 includes a supply line 105 that is connected via corresponding valve elements 108 and gas lines 106 to respective sources 107 of gaseous components such as ammonia (NH₃), nitrogen (N₂) and silane (SiH₄). Furthermore, an exhaust line 109 is provided at the reaction chamber 101 and is connected to a pump source (not shown).

FIG. 2a schematically shows a cross-sectional view of the substrate 110 comprising a bottom layer 111 that may include various material layers having formed therein semiconductor devices such as transistors, resistors, capacitors and the like. Over the bottom layer 111, an insulating layer 112 is formed comprising openings that have been filled with a metal, such as copper, to form metal regions 113 having an exposed surface 114. It is to be noted that although the present invention is described with reference to a semiconductor device including a plurality of electrically active components, the present invention is also applicable to any semiconductor structure comprising an exposed metal surface, no matter whether the exposed metal surface represents a contiguous surface that may cover the entire substrate, or whether the metal surface includes one or more metal regions that may be electrically isolated from each other by an insulating layer, such as the insulating layer 112.

As previously explained, in one illustrative embodiment, the insulating layer 112 and the metal regions 113 represent one of a plurality of copper metallization layers used in high end integrated circuits, such as CPUs adapted to operate at high clock frequencies.

As has been explained in the introductory part of the application, a CMP step may have been performed prior to inserting the substrate 110 into the reaction chamber 101 for the subsequent removal of copper oxide formed on the surface 114. According to one illustrative embodiment, initially, ammonia with a flow rate of approximately 260 sccm and nitrogen with a flow rate of approximately 8600 sccm is introduced into the reaction chamber 101 by means of the feed line 105 and by setting the corresponding valve elements 108. The pump source (not shown) connected to the exhaust line 109 is controlled to establish a pressure of approximately 4.8 Torrs within the reaction chamber 101. A temperature of the substrate 110 is controlled to about 400° C. by a heating means (not shown) that may be provided, for example, within the substrate stage 102. These process parameters are maintained for about 10 seconds to establish a dynamic equilibrium of the gaseous ambient surrounding the substrate 110.

As a next step, the high frequency power source 104 is activated to supply a high frequency power of about 50 Watts to the electrode 103. The application of the high frequency power creates a reactive plasma ambient at the substrate 110 and leads to a significant reduction or even complete removal of copper oxide portions, such as eroded portions and discolored portions, from the surface 114. The surface treatment of the metal region 113 is maintained for about 15 seconds by providing the reactive plasma ambient with the above parameters. As will be explained later, substantially all oxidized and/or discolored portions on the surface 114 are removed.

According to further illustrative embodiments, the time interval for creating a reactive plasma ambient at the presence of a reactive gas, such as ammonia (NH₃), and a purge gas, such as nitrogen (N₂), may be varied from about 2-40 seconds, depending on the required characteristics of the surface 114 of the metal regions 113. That is, treating the surface 114, such as a copper surface, with a reactive plasma ambient creates a process-induced surface roughness that depends on the duration of the surface treatment and the specific treatment conditions. In general, a high HF power and/or a high concentration of reactive gas and/or a long treatment time will result in a high surface roughness or hillock formation. The surface quality, however, affects the adhesion to an overlying material layer and also influences the degree of electromigration of the metal during operation of the device. According to the present invention, the reactive gas ammonia (NH₃) is “diluted” with the purge gas nitrogen (N₂) to significantly reduce surface deformation which would otherwise occur when employing a pure ammonia (NH₃), as is the case in the prior art. Moreover, by varying the treatment time, which may be significantly shorter than in prior art, and/or the high frequency power and/or the ratio between ammonia (NH₃) and nitrogen (N₂), the degree of hillock formation can be adjusted to a desired level. To achieve the required surface quality while still maintaining a substantially oxide-free surface, the high frequency power may be varied within a range of approximately 35-200 Watts, the ratio of nitrogen (N₂):ammonia (NH₃) may be varied within a range of approximately 20-60, whereas the treatment time may be selected within 2-40 seconds. By reducing the high frequency power and by selecting a relatively short treatment time, a deformation of the copper surface 114 due to the reactive plasma ambient may be minimized while still ensuring a required removal rate of oxidized portions on the surfaces 114.

As previously explained, when copper is used as the metal region 113, the surface 114 is extremely sensitive to oxidation, and therefore a capping layer is formed in an in situ process to passivate the copper regions 113. According to one illustrative embodiment, silane (SiH₄) is introduced into the reaction chamber 101 with a flow rate of approximately 150 sccm, wherein the high frequency power is increased to about 500 Watts. Other process parameters remain unchanged, i.e., the temperature may be in the range of approximately 350-450° C., and preferably at approximately 400° C., the pressure in the reaction chamber 101 may selected within a range of approximately 4.0-5.5 Torrs, and preferably at about 4.8 Torrs, the NH₃ flow rate may be in the range of 150-300 sccm, preferably at approximately 260 sccm, and the flow rate of N₂ may be within the range of about 7500-9500 sccm.

As can be seen in FIG. 2b, after a deposition time of approximately 10-20 seconds and, in one particular embodiment, of about 14 seconds, a silicon-containing capping layer 115 is formed over the metal regions 113 with a thickness of approximately 300-800 Å, depending on the specific parameters such as deposition time, silane flow rate, and high frequency power.

Subsequently, the high frequency source 104 is turned off and the introduction of silane and ammonia (NH₃) is stopped to purge the reaction chamber 101 with nitrogen (N₂) at a flow rate of about 7000-9500 sccm, and, in one particular embodiment, at a flow rate of approximately 8600 sccm. In view of reduced overall process time, a purge time of approximately 10 seconds may be selected, which allows a sufficient removal of reactive gas components and reaction by-products. Finally, a pump step of about 10-30 seconds, and preferably of about 15 seconds, with the nitrogen (N₂) supply turned off completes the deposition cycle.

As can be seen from the above illustrative embodiments, a total process time for treating the surface portions 114 and for depositing the silicon-containing capping layer 115 is within a range of approximately 50-90 seconds, and is thus significantly smaller than the total process time of approximately 140 seconds according to the prior art processing. As a consequence, according to the present invention, throughput is remarkably increased and this allows the implementation of the inventive method into more or all metallization processes performed during manufacturing of ultra-high density integrated circuits. Moreover, the process in conformity with the above-identified parameter ranges in accordance with the plurality of illustrative embodiments exhibits an excellent degree of removal of copper oxide, and thus represents an excellent cleaning step after a CMP treatment of copper metallization regions, on which a silicon-containing capping layer is to be subsequently formed. Contrary to the prior art processing, the mixture of a reactive gas and a purge gas during the surface treatment surprisingly leads to an enhanced removal rate of oxidized portions and allows one to employ a relatively short plasma treatment and a relatively low amount of high-frequency power, which results in both a minimized roughness of the copper surface 114 and in significantly reduced copper hillocks in comparison to a copper surface 114 treated in the presence of pure ammonia (NH₃), as will be shown later.

In order to confirm the superior characteristics of an interface between a copper surface and an overlying silicon-containing capping layer, the inventors made numerous test runs to quantitatively evaluate the improvement in comparison over the prior art processing. Test wafers have been prepared with a blanket copper surface and with a patterned insulating layer comprising a plurality of copper regions having an exposed surface.

Investigations of the interface between the copper and a silicon nitride layer formed on the copper by means of Auger analysis confirmed that depending on the ratio of treatment gas and purge gas, the high frequency power and the treatment time, the oxide at the copper surface can be removed most efficiently. In one illustrative embodiment, employing approximately 260 sccm ammonia (NH₃), 8600 sccm nitrogen (N₂), a high frequency power of approximately 50 Watts and a treatment time of about 15 seconds resulted in an oxygen concentration at the interface that is at the detection tool's minimum measurement accuracy of 0.5 atom % and beyond. According to these results, the oxygen contents at the interface copper/silicon nitride is about 25-50 times less than the oxygen contents obtained without any treatment of the copper surface prior to forming the capping layer, and is about two times less than the oxygen contents obtained with a treatment in accordance with the prior art process previously described, i.e., a treatment with ammonia (NH₃) without nitrogen (N₂). Consequently, the present invention reduces the amount of oxygen while at the same time allowing a considerably reduced process time.

Regarding the adhesion characteristics of the interface between the copper regions and the silicon nitride capping layer, measurements were performed using a carbon adhesive tape test, a 4-point bending method, and low-temperature delamination-test. All of the adhesion tests confirmed a sufficient quality of the interface generated in accordance with the present invention. Table 1 below shows the results of a 4-point bending test on interfaces generated by varying process conditions, including a comparative example in accordance with prior art processing (denoted as pure NH₃) and a comparative example without treatment.

TABLE 1
4-Point Bending Test

| Treatment | Time (sec) | HF Power (Watt) | Adhesion (J/m²) |
|---|---|---|---|
| Pure NH₃ | 40 | 200 | >15 |
| NH₃ + N₂ | >15 | 100-200 | >15 |
| NH₃ + N₂ | 10-15 | 50-100 | 10-20 |
| NH₃ + N₂ | 2-10 | 20-100 | 5-10 |
| No treatment | — | — | 5-10 |

From this table, it is evident that a treatment with pure ammonia (NH₃) (prior art processing) results in an adhesion value of more than 15 joules/m², thereby requiring a treatment time of 40 seconds with a high frequency power of 200 Watts. Contrary thereto, one embodiment of the present invention using a mixture of ammonia (NH₃) and nitrogen (N₂) with a treatment time in excess of 15 seconds and a high frequency power of 100-200 Watts results in approximately the same adhesion value, wherein, however, the treatment time is significantly less than in the prior art processing and, thus, as previously explained, the degree of surface deformation is significantly reduced. A further reduction of treatment time to about 10-15 seconds and a further decrease of the high frequency power to 50-100 Watts leads to adhesion values of 10-20 J/m², which is a value that is still appropriate for any type of metallization layers. Finally, a treatment time of 2-10 seconds with a high frequency power of 20-100 Watts results in adhesion values of 5-10 joules/m², which is still sufficient for, e.g., the metallization layers that are located closer to the active devices. As is apparent from this table, samples with more effectively reduced copper oxide, i.e., longer treatment time and higher high frequency power, exhibit higher adhesion values due to the rougher surface caused by the reactive plasma treatment, which, on the other hand, will cause increased electromigration during operation of the final integrated circuit. With a treatment of about 5 seconds at 50 Watts with an ammonia (NH₃) plus nitrogen (N₂) mixture, the adhesion values are close to the values obtained for untreated copper surfaces. Contrary thereto, however, the most efficient oxide reduction (25-50 times less) leads to a significantly reduced leakage current on copper damascene structures, used as metallization layers in high end integrated circuits, and to a remarkably improved performance with respect to electromigration.

A visual inspection (optical microscope) confirmed that the density of hillocks on a treated copper surface with a 2-5 second ammonia (NH₃)/nitrogen (N₂) treatment and a high frequency power of less than 50 Watts resulted in a hillock density of about ten times less than a 40 second/200 Watts treatment in accordance with the prior art processing. These results are representative for patterned and unpatterned wafers.

As a result, based on specific applications and requirements, the treatment time and the high frequency power can be increased to obtain higher adhesion values, particularly when interfaces on top of interlayer dielectric layers (ILD layers) adjacent to bond pad areas are formed since these areas have to provide a highly reliable mechanical connection to the bond pads. On the other hand, at lower-level metallization layers, where the adhesion values may be selected lower than at the bonding area of the semiconductor chip, shorter treatment times with reduced high frequency power may be applied to obtain a high throughput and superior characteristics with respect to leakage current and electromigration.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method of treating a copper surface, comprising:
providing a substrate having formed thereon one or more copper-containing regions with an exposed surface having oxidized and discolored portions formed thereon;
providing a gaseous ambient comprising a mixture of ammonia and nitrogen; and
establishing a reactive plasma ambient by supplying high frequency power to the gaseous ambient to remove said oxidized and discolored portions from the exposed surface of said copper-containing regions.

2. The method of claim 1, wherein a ratio of nitrogen and ammonia is in the range of approximately 20-60.

3. The method of claim 1, wherein a flow rate of ammonia is in the range of approximately 150-350 sccm.

4. The method of claim 3, wherein the flow rate of ammonia is approximately 260 sccm.

5. The method of claim 1, wherein a flow rate of nitrogen is in the range of approximately 7000-9500 sccm.

6. The method of claim 5, wherein the flow rate of nitrogen is approximately 8600 sccm.

7. The method of claim 1, wherein a high frequency power is supplied to establish said reactive gas plasma in the range of approximately 35-200 Watts.

8. The method of claim 1, wherein a temperature of the substrate is approximately 350-450° C.

9. The method of claim 1, wherein a pressure of the reactive plasma ambient is in the range of approximately 4.0-5.5 Torrs.

10. The method of claim 1, wherein a treatment time for removing oxidized and discolored portions from the exposed surface is in the range of approximately 3-40 seconds.

11. The method of claim 1, further comprising adding silane to the reactive plasma ambient to deposit a silicon-containing capping layer on the exposed surface.

12. The method of claim 11, wherein silane is provided with a flow rate of approximately 100-200 sccm.

13. The method of claim 12, wherein silane is provided for about 10-20 seconds.

14. The method of claim 1, further comprising performing a purge step and a pump step after depositing the silicon-containing capping layer.

15. The method of claim 1, wherein a total process time is in the range of approximately 50-90 seconds.

16. A method of treating a copper surface, comprising:
providing a substrate having formed thereon one or more copper-containing regions with an exposed surface having oxidized and discolored portions formed thereon;
providing a gaseous ambient comprising a mixture of nitrogen and ammonia in a ratio of approximately 20-60, nitrogen to ammonia; and
establishing a reactive plasma ambient by supplying high frequency power to the gaseous ambient to remove said oxidized and discolored portions from the exposed surface of said copper-containing regions.

17. The method of claim 16, wherein a flow rate of ammonia is in the range of approximately 150-350 sccm.

18. The method of claim 17, wherein the flow rate of ammonia is approximately 260 sccm.

19. The method of claim 16, wherein a flow rate of nitrogen is in the range of approximately 7000-9500 sccm.

20. The method of claim 19, wherein the flow rate of nitrogen is approximately 8600 sccm.

21. The method of claim 16, wherein a high frequency power is supplied to establish said reactive gas plasma in the range of approximately 35-200 Watts.

22. The method of claim 16, wherein a temperature of the substrate is approximately 350-450° C.

23. The method of claim 16, wherein a pressure of the reactive plasma ambient is in the range of approximately 4.0-5.5 Torrs.

24. The method of claim 16, wherein a treatment time for removing oxidized and discolored portions from the exposed surface is in the range of approximately 3-40 seconds.

25. The method of claim 16, further comprising adding silane to the reactive plasma ambient to deposit a silicon-containing capping layer on the exposed surface.

26. The method of claim 25, wherein silane is provided with a flow rate of approximately 100-200 sccm.

27. The method of claim 26, wherein silane is provided for about 10-20 seconds.

28. The method of claim 16, further comprising performing a purge step and a pump step after depositing the silicon-containing capping layer.

29. The method of claim 16, wherein a total process time is in the range of approximately 50-90 seconds.

30. A method of treating a copper surface, comprising:
providing a substrate having formed thereon one or more copper-containing regions with an exposed surface having oxidized and discolored portions formed thereon;
providing a gaseous ambient comprising a mixture of ammonia and nitrogen, said ammonia being provided at a flow rate in the range of approximately 150-350 sccm and said nitrogen being provided at a flow rate in the range of approximately 7000-9500 sccm; and
establishing a reactive plasma ambient by supplying high frequency power to the gaseous ambient to remove said oxidized and discolored portions from the exposed surface of said copper-containing regions.

31. The method of claim 30, wherein the flow rate of ammonia is approximately 260 sccm.

32. The method of claim 30, wherein the flow rate of nitrogen is approximately 8600 sccm.

33. The method of claim 30, wherein a high frequency power is supplied to establish said reactive gas plasma in the range of approximately 35-200 Watts.

34. The method of claim 30, wherein a temperature of the substrate is approximately 350-450° C.

35. The method of claim 30, wherein a pressure of the reactive plasma ambient is in the range of approximately 4.0-5.5 Torrs.

36. The method of claim 30, wherein a treatment time for removing oxidized and discolored portions from the exposed surface is in the range of approximately 3-40 seconds.

37. The method of claim 30, further comprising adding silane to the reactive plasma ambient to deposit a silicon-containing capping layer on the exposed surface.

38. The method of claim 30, wherein silane is provided with a flow rate of approximately 100-200 sccm.

39. The method of claim 30, wherein silane is provided for about 10-20 seconds.

40. The method of claim 30, further comprising performing a purge step and a pump step after depositing the silicon-containing capping layer.

41. The method of claim 30, wherein a total process time is in the range of approximately 50-90 seconds.

42. An in situ method of forming a silicon-containing capping layer on a metal surface, the method comprising:
providing a substrate having formed thereon a metal region with an exposed surface having oxidized portions formed thereon;
establishing a reactive plasma ambient by supplying high frequency power to a gaseous ambient comprising a mixture of a reactive gas and a purge gas to reduce said oxidized portions on the metal surface; and
adding silane gas to deposit the silicon-containing capping layer on the metal surface.

43. The method of claim 42, wherein the silane gas is added to said reactive plasma ambient.

44. The method of claim 42, wherein said reactive gas is comprised of ammonia and said purge gas is comprised of nitrogen and wherein a ratio of nitrogen and ammonia is in the range of 20-60.

45. The method of claim 42, wherein a flow rate of ammonia is in the range of approximately 150-350 sccm.

46. The method of claim 45, wherein the flow rate of nitrogen is approximately 260 sccm.

47. The method of claim 42, wherein a flow rate of nitrogen is in the range of approximately 7000-9500 sccm.

48. The method of claim 47, wherein the flow rate of nitrogen is approximately 8600 sccm.

49. The method of claim 42, wherein the high frequency power applied during reducing the oxidized portions on the exposed surface is in the range of approximately 35-200 Watts.

50. The method of claim 42, wherein a temperature of the substrate is approximately 350-450° C.

51. The method of claim 42, wherein a pressure of the reactive plasma ambient is in the range of approximately 4.0-5.5 Torrs.

52. The method of claim 42, wherein a treatment time for reducing surface irregularities is in the range of approximately 3-40 seconds.

53. The method of claim 42, wherein silane is provided for about 10-20 seconds.

54. The method of claim 42, further comprising performing a purge step and a pump step after depositing the silicon-containing capping layer.

55. The method of claim 42, wherein a total process time is in the range of approximately 50-90 seconds.
